(19) United States
(12) Patent Application Publication
(10) Pub. No.: US 2017/0187073 A1
(43) Pub. Date: Jun. 29, 2017

(54) LITHIUM SECONDARY BATTERY

(71) Applicant: SK INNOVATION CO., LTD., Seoul (KR)

(72) Inventors: Dong Ju KIM, Daejeon (KR); Jin Go KIM, Daejeon (KR); Tae Il KIM, Daejeon (KR); Seung Noh LEE, Daejeon (KR)

(21) Appl. No.: 15/386,948

(22) Filed: Dec. 21, 2016

(30) Foreign Application Priority Data
Dec. 23, 2015 (KR) 10-2015-0184716

(51) Int. Cl. H01M 10/0587; H01M 10/6554; H01M 10/0525

(52) U.S. Cl. CPC H01M 10/0587; H01M 10/0525; H01M 10/6554

(57) ABSTRACT

A lithium secondary battery includes a case, a jelly roll housed in the case, the jelly roll including a plurality of electrode plates and a separation film disposed between the plurality of electrode plates, and a heat conduction plate disposed on both sides of the jelly roll and housed in the case together with the jelly roll.

### CROSS REFERENCE TO RELATED APPLICATIONS AND CLAIM OF PRIORITY

The application claims the benefit of Korean Patent Application No. 10-2015-0184716, filed on Dec. 23, 2015, at the Korean Intellectual Property Office, the disclosure of which is incorporated by reference herein in their entirety.

### BACKGROUND

1. Technical Field

Embodiments of the present invention relate to a lithium secondary battery.

2. Description of the Related Art

Recently, compact and light-weighted electric/electronic devices such as a mobile phone, a laptop computer, a camcorder, and the like have been actively developed and produced. These electric/storage devices have a battery pack embedded therein to be operated at places without a separate power source.

In addition, vehicles using a motor such as a hybrid vehicle (HV), an electric vehicle (EV), and the like have been developed and produced. These vehicles also have a battery pack embedded therein capable of operating the motor. The above-described battery pack includes at least one battery so that it can generate a voltage at a predetermined level to drive the electric/storage devices or vehicles for a prescribed period of time.

In consideration of economic aspects, a rechargeable secondary battery has been employed in the battery pack. Among the existing secondary batteries, the lithium secondary battery has a high unit battery voltage (3.0 to 3.7 V), a high energy density without a memory effect, a low natural discharge property, and is very lightweight. Therefore, the lithium secondary battery is widely used in various portable electronic devices such as a laptop computer, a camera, a mobile phone, and the like. In addition, the lithium secondary battery is employed in fields such as defense industries, automated systems, vehicles, and aerospace industries due to its high energy density.

Meanwhile, as the battery becomes widespread, safety issues have been also raised. For example, the battery pack may be deformed due to an external impact or penetrated by a sharp object. In particular, the battery pack of the electric vehicle may be penetrated when an accident occurs.

When the battery pack is penetrated as described above, an anode and a cathode in a charged state may be in a physical contact with each other. Accordingly, a high current may flow in a penetrated portion in a short period of time to cause an abnormal heating. For example, an organic electrolyte may serve as a fuel in a combustion reaction of the battery to cause a spontaneously combustion. A combustion heat may be accumulated in battery cells so that a temperature of the battery may continuously increase to induce a series of pyrolytic reactions. As a result, an ignition or explosion may occur in the portable electronic device.

In particular, in transport devices such as electrical vehicles, penetration safety is an issue directly relating to life of a passenger. Therefore, when the penetration safety is not secured, an application of the lithium secondary battery to the transport devices is limited, and the safety of the battery is becoming a more important issue in, e.g., vehicle fields which require a high capacity of power supply.

Regarding the above-described problems, Korean Patent Laid-Open Publication No. 2013-0042920 discloses a secondary battery including one or more pouch containing a foaming agent. However, the document fails to disclose solutions for overcoming the foregoing problems.

### SUMMARY

Accordingly, it is an aspect of the present invention to provide a lithium secondary battery which may rapidly disperse high heat generating when an internal short circuit occurs due to penetration, thus to improve safety by suppressing a temperature increase.

According to embodiments of the present invention, there is provided a lithium secondary battery including: a case; a jelly roll housed in the case, the jelly roll including a plurality of electrode plates and a separation film disposed between the plurality of electrode plates; and a heat conduction plate disposed on both sides of the jelly roll and housed in the case together with the jelly roll.

In some embodiments, the separation film may be disposed at a portion of the jelly roll contacting the heat conduction plate.

In some embodiments, the heat conduction plate may have electrical conductivity.

In some embodiments, the heat conduction plate may include a metal.

In some embodiments, the heat conduction plate may have a thickness of 1 to 20 μm.

In some embodiments, the heat conduction plate may include a plurality of through holes.

In some embodiments, the heat conduction plate may be a laminate of a plurality of unit plates.

The lithium secondary battery according to embodiments of the present invention may rapidly disperse high heat generated when internal short circuit occurs due to penetration, thus to improve safety by reducing a temperature increase.

In addition, when the heat conduction plate also has electrical conductivity, the lithium secondary battery may provide a path for short circuit current during an occurrence of internal short circuit due to penetration, thereby more effectively suppressing the temperature increase in the battery.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a cross-sectional view schematically illustrating a construction of a lithium secondary battery according to an embodiment of the present invention.

### DETAILED DESCRIPTION OF EMBODIMENTS

Example embodiments of the present invention provide a lithium secondary battery including: a case; a jelly roll housed in the case which includes a plurality of electrode plates and a separation film disposed between the plurality of electrode plates; and a heat conduction plate on both sides of the jelly roll, so that high heat generated during an internal short circuit may be rapidly dispersed to improve safety by reducing a temperature increase.

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

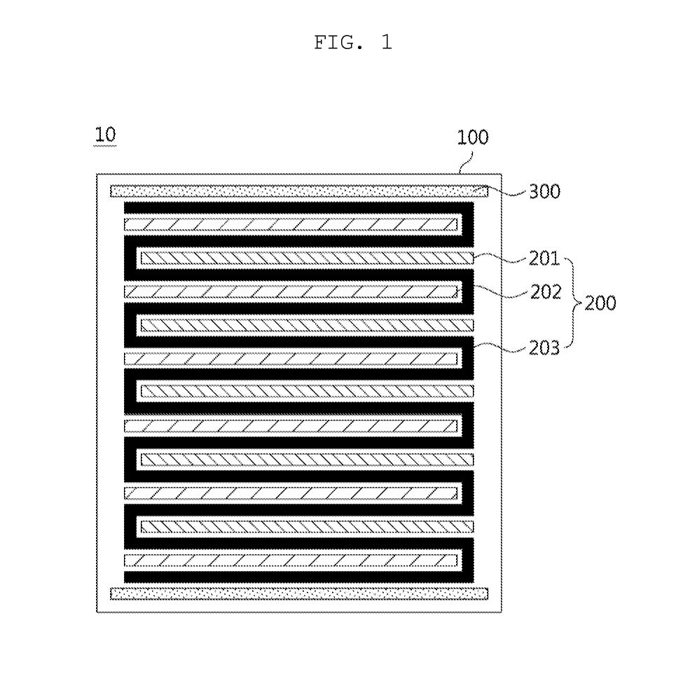

FIG. 1 is a cross-sectional view schematically illustrating a lithium secondary battery 10 according to an embodiment of the present invention. FIG. 1 schematically illustrates the lithium secondary battery 10 including a jelly roll 200 housed in a case 100, and a heat conduction plate 300 which is disposed on both sides of the jelly roll 200 to be housed in the case 100 together with the jelly roll 200, as one embodiment of the present invention.

Since the lithium secondary battery 10 according to the embodiment of the present invention includes the heat conduction plate 300 disposed on both sides of the jelly roll 200, high heat generated when internal short circuit occurs due to, e.g. a penetration of an external object may be rapidly dispersed to improve safety by reducing a temperature increase.

In addition, since the heat conduction plate 300 is disposed on both sides of the jelly roll 200, safety and reliability of the battery may be obtained even when a slight penetration at an outer portion of the jelly roll 200 occurs.

The heat conduction plate 300 according to embodiments of the present invention may not be particularly limited so long as it is formed of a material having thermal conductivity. The heat conduction plate 300 may include, for example, a metal, a thermally conductive ceramic, a thermally conductive carbon-based material, a thermally conductive polymer, or the like.

In one embodiment of the present invention, preferably, the heat conduction plate 300 may further have electrical conductivity. When the heat conduction plate 300 has the electrical conductivity, a path of short circuit current may be also provided during an occurrence of internal short circuit due to penetration. Thus, the temperature increase of the battery may be effectively suppressed. In consideration of the aspect, the heat conduction plate 300 may preferably include a metal, for example, copper, aluminum, or the like.

A thickness of the heat conduction plate 300 is not particularly limited, but may be in a range from, e.g., about 1 to about 20 μm. When the thickness thereof is within the above range, thermal conductivity may be achieved without significantly decreasing an energy density to rapidly disperse the high heat generated during the internal short circuit.

In one embodiment of the present invention, the heat conduction plate 300 may include a plurality of through holes. The through hole may serve as a carrier of an electrolyte, when inputting the electrolyte into the lithium secondary battery. For example, the through holes of the heat conduction plate 300 may also carry the electrolyte, while the jelly rolls 200 are immersed in the electrolyte.

In particular, when injecting the electrolyte, the electrolyte may also be injected into a region occupied by the heat conduction plate 300, so that, when the electrolyte is completely injected, the heat conduction plate 300 may include the electrolyte in the through holes.

Accordingly, an amount of the electrolyte immersed in the lithium secondary battery may be increased by the through holes of the heat conduction plate 300 so that a long-term reliability of the lithium secondary battery may be improved.

The through hole formed in the heat conduction plate 300 may has a circular or polygonal shape.

The heat conduction plate 300 may have a single-layered structure or a multi-layered structure including a plurality of unit plates. For example, one to five unit plates may be stacked to form the heat conduction plate 300.

The jelly roll 200 according to the embodiment of the present invention may have a construction in which unit cathode plates 201 and unit anode plates 202 are alternately arranged with respect to a separation film 203 interposed therebetween.

In one embodiment of the present invention, the jelly roll 200 may be housed in the case 100, and the heat conduction plates 300 may be disposed on both sides of the jelly roll 200. In this case, in order to prevent a direct contact between the electrode plates 201 and 202, and the heat conduction plate 300, the separation film 203 may be disposed at a portion of the jelly roll 200 contacting the heat conduction plate 300. Specifically, the jelly roll 200 may have a construction in which the separation film 203 is interposed between the outermost electrode of the jelly roll 200 and the heat conduction plate 300.

In one embodiment of the present invention, the jelly roll 200 may include the same outermost electrodes as each other. The outermost electrode may be the cathode plate 201 or the anode plate 202, and is preferably, the anode plate 202.

The cathode plate 201 and the anode plate 202 may be formed by coating a cathode active material layer and an anode active material layer on at least one surface of a collector, respectively. Each active material of the cathode active material layer and the anode active material layer may include any material commonly used in the related art, without particular limitation thereof.

The anode active material is not particularly limited, and may include any material commonly used as the anode active material in the related art. For example, carbon-based materials such as crystalline carbon, amorphous carbon, carbon composite, carbon fiber, etc., lithium metal, alloys of lithium and other elements, silicon, or tin may be used. The amorphous carbon may include, for example, hard carbon, cokes, mesocarbon microbead (MCMB) calcined at a temperature of 1500° C. or less, mesophase pitch-based carbon fiber (MPCF), or the like. The crystalline carbon may include graphite materials, and specifically, natural graphite, graphite cokes, graphite MCMB, graphite MPCF, or the like. Other elements forming an alloy with lithium may include, for example, aluminum, zinc, bismuth, cadmium, antimony, silicon, lead, tin, gallium or indium.

The cathode active material is not particularly limited, and may include any material commonly used as the cathode active material in the related art. For example, one or more of composite oxides of lithium and at least one selected from cobalt, manganese, and nickel may be preferably used. In an embodiment, a lithium containing compound described below maybe preferably used.

LiₓMn_{1-y}M_{y}A₂ (1)

LiₓMn_{1-y}M_{y}O_{2-z}X_{z} (2)

LiₓMn₂O_{4-z}X_{z} (3)

LiₓMn_{2-y}M_{y}M′_{z}A₄ (4)

LiₓCo_{1-y}M_{y}A₂ (5)

LiₓCo_{2-y}M_{y}O_{2-z}X_{z} (6)

LiₓNi_{1-y}M_{y}A₂ (7)

LiₓNi_{1-y}M_{y}O_{2-z}X_{z} (8)

LiₓNi_{1-y}Co_{y}O_{2-z}X_{z} (9)

LiₓNi_{1-y-z}Co_{y}M_{z}A_{α} (10)

LiₓNi_{1-y-z}Co_{y}M_{z}O_{2-α}X_{α} (11)

LiₓNi_{1-y-z}Mn_{y}M_{z}A_{α} (12)

LiₓNi_{1-y-z}Mn_{y}M_{z}O_{2-α}X_{α} (13)

In the formulae above, 0.9≦x≦1.1, 0≦y≦0.5, 0≦z≦0.5, and 0≦α≦2, M and M′ are the same as or different from each other and may be selected from the group consisting of Mg, Al, Co, K, Na, Ca, Si, Ti, Sn, V, Ge, Ga, B, As, Zr, Mn, Cr, Fe, Sr, V and rare-earth elements, A is selected from a group consisting of O, F, S and P, and X is selected from a group consisting of F, S and P.

The cathode active material layer and the anode active material layer may optionally include a binder, a conductive material, a dispersant, or the like, other than the active materials. These components are mixed and agitated together with a solvent to prepare a slurry. Then, the slurry may be applied (coated) on a collector, and pressed and dried to form an electrode active material layer.

The collector may include any metal having high conductivity and capable of being easily attached with a mixture of the cathode or anode active materials, while it does not have reactivity in the voltage range of the battery.

An anode collector may use copper or an alloy of copper, but it is not limited thereto, and may include: stainless steel, nickel, copper, titanium, or an alloy thereof; a material which is subjected to surface treatment with carbon, nickel, titanium, or silver on a surface of copper or stainless steel, or the like.

A cathode collector may include aluminum or an alloy of aluminum, but it is not limited thereto, and may include: stainless steel, nickel, aluminum, titanium, or an alloy thereof; a material which is subjected to surface treatment with carbon, nickel, titanium, or silver on a surface of aluminum or stainless steel, or the like.

In addition, a shape of the collector is not particularly limited, and may have shapes commonly known in the related art. For example, a planar collector, a hollow collector, a wire type collector, a wound wire type collector, a wound sheet type collector, a mesh type current collector, or the like may be used.

To insulate the cathode plate 201 and the anode plate 202 from each other, the separation film 203 may be interposed between the cathode plate 201 and the anode plate 202. A material of the separation film 203 is not particularly limited so long as it is an insulation material. For example, the separation film 203 may be formed from a porous membrane that allows ions to move between the cathode plate 201 and the anode plate 202.

A particular example of the separation film 203 may include a thin film having high ion permeability and mechanical strength. In particular, an olefin polymer such as chemical resistance and hydrophobic polypropylene; a sheet or non-woven fabric formed of glass fiber or polyethylene, etc. may be used.

The separation film 203 may further include an inorganic material layer on at least one surface thereof so that safety of the separation film and the battery may be further improved.

The inorganic particle layer may be formed of an inorganic material and a binder. The inorganic particles may include any material capable of achieving the above-described purpose, and may include at least one selected from alumina, aluminum hydroxide, silica, barium oxide, titanium oxide, magnesium oxide, magnesium hydroxide, clay, glass powders, boehmite or a mixture thereof, and more specifically, when using the alumina as the inorganic particles, the separation film 203 may have an excellent stiffness, and effectively prevents a short circuit caused by dendrite and foreign matters.

When using a solid electrolyte, e.g., a polymer as the electrolyte, the solid electrolyte may also serve as the separation film. Preferably, the solid electrolyte may include a polyethylene film, polypropylene film, or a multi-layered film prepared by a combination thereof, a polymer film such as polyvinylidene fluoride, polyethylene oxide, polyacrylonitrile, or polyvinylidene fluoride hexafluoropropylene copolymer, or the like, but it is not limited thereto.

The jelly roll 200 and the heat conduction plate 300 may be housed in the case 100 together with a non-aqueous electrolyte to prepare the lithium secondary battery. The non-aqueous electrolyte may include any material widely known in the related art.

A material of the case 100 according to the embodiment of the present invention may include any material known in the related art without particular limitation thereof. For example, the case 100 may be a can, pouch, or the like.

In a case of the pouch, the pouch may be formed in a plurality of flexible layers, and may include, for example, a thermal adhesion layer, a metal layer, and a polymer resin layer.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Preparative Example

<Cathode Plate>

LiNi_{0.8}Co_{0.1}Mn_{0.1}O₂ as a cathode active material, carbon black as a conductive material, and polyvinylidene fluoride (PVDF) as a binder were used in a weight ratio of 92:5:3, respectively, to prepare a cathode slurry having the above composition. The slurry was coated on an aluminum substrate, followed by drying and pressing to prepare a cathode electrode.

<Anode Plate>

92% by weight (′wt. %′) of natural graphite as an anode active material, 3 wt. % of styrene butadiene rubber+carboxymethyl cellulose (SBR+CMC) as a binder, 5 wt. % of amorphous graphite as a conductive material were mixed to prepare an anode slurry having the above composition. The slurry was coated on a copper substrate, followed by drying and pressing to prepare an anode electrode.

### Example

A jelly roll was prepared by alternatively laminating the unit anode plates and the unit cathode plates prepared in the above preparative example with a polyethylene separation film interposed therebetween so that the anode plate was arranged as the outermost electrode. Thereafter, four heat conduction plates each having a thickness of 12 μm were laminated and disposed on both sides of the jelly roll, while a portion of the jelly roll contacting the heat conduction plate was the separation film.

The jelly roll combined with the heat conduction plate was housed in a pouch, and an electrolyte was injected therein, followed by sealing the same to prepare a lithium secondary battery.

The electrolyte used herein was formed by preparing 1M LiPF₆ solution with a mixed solvent of EC/EMC/DEC (25/45/30; volume ratio), and adding 1 wt. % of vinylene carbonate (VC), 0.5 wt. % of 1,3-propene sultone (PRS), and 0.5 wt. % of lithium bis(oxalato)borate (LiBOB) thereto.

### Comparative Example

The same procedures as described in the above example were conducted to prepare a lithium secondary battery except that the heat conduction plate was not used.

Evaluation of Penetration Safety

To evaluate the penetration safety for the lithium secondary batteries, nine samples in the example and the comparative example were prepared, and then a nail penetration test was performed according to state of charge (SOC) using a stainless steel nail having a diameter of 5 mm. The penetration safety was evaluated according to the following standards for evaluation, and the evaluated results are shown in Table 1 below.

<Standards for Evaluation, EUCAR Hazard Level>

L1: no occurrence of abnormality in a battery performance

L2: irreversible damage occurred in a battery performance

L3: weight of electrolyte in the battery was decreased by less than 50%

L4: weight of electrolyte in the battery was decreased by 50% or more

L5: ignition or explosion occurred in the battery

TABLE 1

Results of nail
penetration test
(EUCAR Hazard Level)

| State of charge | | Comparative |
|---|---|---|
| (SOC) | Example | Example |
| 60% | 3L4 | 3L5 |
| 50% | 3L4 | 3L5 |
| 40% | 3L4 | 3L4 |

4L4 means that the four samples are L4 (a numeral before the EUCAR Hazard Level is the number of the evaluated samples)

Referring to Table 1, the lithium secondary battery according to the example showed excellent penetration safety.

What is claimed is:

1. A lithium secondary battery, comprising:
a case;
a jelly roll housed in the case, the jelly roll including a plurality of electrode plates and a separation film disposed between the plurality of electrode plates; and
a heat conduction plate disposed on both sides of the jelly roll and housed in the case together with the jelly roll.

2. The lithium secondary battery according to claim 1, wherein the separation film is disposed at a portion of the jelly roll contacting the heat conduction plate.

3. The lithium secondary battery according to claim 1, wherein the heat conduction plate has electrical conductivity.

4. The lithium secondary battery according to claim 1, wherein the heat conduction plate includes a metal.

5. The lithium secondary battery according to claim 1, wherein the heat conduction plate has a thickness of 1 to 20 μm.

6. The lithium secondary battery according to claim 1, wherein the heat conduction plate includes a plurality of through holes.

7. The lithium secondary battery according to claim 1, wherein the heat conduction plate is a laminate of a plurality of unit plates.
